(19) United States
(12) Patent Application Publication
(10) Pub. No.: US 2015/0242213 A1
(43) Pub. Date: Aug. 27, 2015

(54) SYSTEM AND METHOD FOR MODIFICATION OF CODED INSTRUCTIONS IN READ-ONLY MEMORY USING ONE-TIME PROGRAMMABLE MEMORY

(71) Applicant: QUALCOMM INCORPORATED, SAN DIEGO, CA (US)

(72) Inventors: YANRU LI, SAN DIEGO, CA (US); DEXTER TAMIO CHUN, SAN DIEGO, CA (US); DHAMIM PACKER ALI, SAN DIEGO, CA (US); GREGORY AMERIADA UVIEGHARA, MURRIETA, CA (US); ZHONGZE WANG, SAN DIEGO, CA (US)

(73) Assignee: QUALCOMM INCORPORATED, SAN DIEGO, CA (US)

(21) Appl. No.: 14/187,272

(22) Filed: Feb. 23, 2014

(51) Int. Cl. G06F 9/38

(52) U.S. Cl. CPC G06F 9/3802

(57) ABSTRACT

Various embodiments of methods and systems for flexible read only memory (“ROM”) storage of coded instructions in a portable computing device (“PCD”) are disclosed. Because certain instructions and/or data associated with a primary boot loader (“PBL”) may be defective or in need of modification after manufacture of a mask ROM component, embodiments of flexible ROM storage (“FRS”) systems and methods use a closely coupled one-time programmable (“OTP”) memory component to store modified instructions and/or data. Advantageously, because the OTP memory component may be manufactured “blank” and programmed at a later time, modifications to code and/or data stored in an unchangeable mask ROM may be accomplished via pointers in fuses of a security controller that branch the request to the OTP and bypass the mask ROM.

### DESCRIPTION OF THE RELATED ART

Portable computing devices (“PCDs”) are becoming necessities for people on personal and professional levels. These devices may include cellular telephones, portable digital assistants (“PDAs”), portable game consoles, palmtop computers, and other portable electronic devices.

One aspect of PCDs that is in common with most computing devices is the use of electronic memory components for storing instructions and/or data. Various types of memory components may exist in a PCD, each designated for different purposes. Commonly, non-volatile read-only memory (“ROM”) such as mask ROM is used to store critical instructions in the form of a primary boot loader (“PBL”) required for the PCD to boot, load operating system (“OS”) software, and transition control of the PCD over to the OS.

Notably, once the mask ROM is encoded with instructions, it cannot be reprogrammed or easily modified. As such, software (i.e., firmware) and data encoded in the mask ROM must be carefully developed prior to being encoded into the mask ROM. If the PBL referred to above, for example, is incorrect when encoded into the mask ROM then the options for “fixing” the PBL may be limited to either application of software patches through a finite number of fuses or, if the required fixes are extensive, complete remanufacture of the mask ROM component.

The security of the mask ROM makes it desirable for storage of PBL instructions, however, the very nature of mask ROM which makes it such a reliable and secure storage medium also limits its flexibility in accommodating post-manufacture changes to the PBL instructions. Accordingly, there is a need in the art for a system and method that provides for on-chip development of the PBL instructions post-manufacture (i.e., post “tape-out”) of the mask ROM. Moreover, there is a need in the art for a system and method that extends the flexibility of current systems and methods for PBL patching and on-chip system on a chip (“SoC”) calibration using fuses. Further, there is a need in the art for a system and method that uses one time programmable (“OTP”) ROM to support modification of PBL instructions stored in mask ROM.

### SUMMARY OF THE DISCLOSURE

Various embodiments of methods and systems for flexible read only memory (“ROM”) storage of coded instructions in a portable computing device (“PCD”) are disclosed. Because certain instructions and/or data associated with a primary boot loader (“PBL”) may be defective or in need of modification after manufacture of a mask ROM component, embodiments of flexible ROM storage (“FRS”) systems and methods use a closely coupled one time programmable (“OTP”) memory component to store modified instructions and/or data. Advantageously, because the OTP memory component may be manufactured “blank” and programmed at a later time, modifications to code and/or data stored in an unchangeable mask ROM may be accomplished via fuses in the security controller that change the instruction to branch to the OTP and bypass the mask ROM.

In operation, an exemplary embodiment of an FRS system and method receives a request for coded instructions (or data) stored at an address of a mask ROM component. The request may emanate from a processing component, such as a CPU, during a boot sequence, for example. The request may be received by the mask ROM as well as a security controller that comprises a plurality of fuses. The security controller may determine that fuses that contain patch instructions or patch data are available for the request, and if a patch is available, the security controller may subsequently cause the patch to be forwarded to a MUX module that returns the patch data to the processing component instead of the original instantiation of the instructions or data stored in the mask ROM.

Furthermore, the fuse might, for example, patch the instruction into a branch instruction that causes the processor to jump to the OTP address space. In such case, the FRS embodiment may cause instructions and/or data stored in the OTP component to be returned to the requesting processing component, thereby causing the mask ROM to be bypassed. In this way, embodiments of an FRS system and method may provide developers with extended memory capacity beyond fuses in the security controller that is useful for making modifications to otherwise unchangeable code or data hard wired into the mask ROM. Advantageously, embodiments of an FRS system and method may reduce the number of fuses required to accommodate changes to the code or data stored in a mask ROM, thereby saving space in a PCD that has a limited form factor.

It is further envisioned that some embodiments of a FRS system and method may utilize a cache by prefetching instructions or data stored in the OTP memory to the cache early in a boot sequence, or by copying instructions or data stored in the OTP memory to the system memory, for example on-chip SRAM, that yield shorter access latency than the OTP. In this way, subsequent requests for the instructions or data stored in the OTP may be made on the faster cache component, thereby more closely approximating the speed of the mask ROM.

### BRIEF DESCRIPTION OF THE DRAWINGS

In the drawings, like reference numerals refer to like parts throughout the various views unless otherwise indicated. For reference numerals with letter character designations such as “102A” or “102B”, the letter character designations may differentiate two like parts or elements present in the same figure. Letter character designations for reference numerals may be omitted when it is intended that a reference numeral to encompass all parts having the same reference numeral in all figures.

FIG. 1 is a functional block diagram illustrating an exemplary, non-limiting aspect of a portable computing device (“PCD”) in the form of a wireless telephone for implementing flexible ROM storage (“FRS”) methods and systems;

FIG. 2 is a functional block diagram illustrating an embodiment of an on-chip system for executing a primary boot loader (“PBL”) stored entirely in a boot ROM of a PCD;

FIG. 3 is a functional block diagram illustrating an embodiment of an on-chip system for executing a PBL of a PCD using a flexible ROM storage (“FRS”) arrangement according to an embodiment of the invention;

FIG. 4 is a functional block diagram illustrating an embodiment of an on-chip system for executing a PBL of a PCD using an FRS arrangement according to an embodiment of the invention that includes a cache or on-chip random access memory (“RAM”);

FIG. 5 is a functional block diagram illustrating an embodiment of an on-chip system for executing a PBL of a PCD using an FRS arrangement according to an embodiment of the invention that branches from mask ROM to Boot OTP; and

FIG. 6 is a logical flowchart illustrating a method for flexible ROM storage of instructions and/or data associated with a PBL.

### DETAILED DESCRIPTION

The word “exemplary” is used herein to mean serving as an example, instance, or illustration. Any aspect described herein as “exemplary” is not necessarily to be construed as exclusive, preferred or advantageous over other aspects.

In this description, the term “application” may also include files having executable content, such as: object code, scripts, byte code, markup language files, and patches. In addition, an “application” referred to herein, may also include files that are not executable in nature, such as documents that may need to be opened or other data files that need to be accessed.

In this description, the term “fuse” is meant to refer to a programmable gate controlled by a security controller that receives a request for instructions or data stored at a memory address, such as an address in a mask ROM memory component. The fuse may contain instructions or data referred to in this description as a “patch” or it may contain a pointer to instructions or data stored in an alternative address, such as an address in an OTP memory component.

In this description, reference to “boot ROM” or “mask ROM” memory components refers to a broader class of non-volatile (i.e., retains its data after power is removed) read only memory and will not limit the scope of the solutions disclosed herein to modification of instructions stored in mask ROM only. That is, it will be understood that various embodiments of the systems and method provide a solution for post-manufacture modification of instructions stored in any non-volatile read only memory at the time of manufacture, whether such memory is reprogrammable or not. Notably, although some types of read only memory other than mask ROM can be erased and re-programmed multiple times, it is envisioned that the cumbersome and slow process of reprogramming such memory types may make them attractive for application of certain embodiments of the solutions disclosed herein.

In this description, reference to one time programmable (“OTP”) memory or “boot OTP” or the like refers to a broader class of non-volatile read only memory to which instructions and/or data may be burned (i.e., saved or stored) after manufacture of the memory and will not limit the scope of the solutions disclosed herein to specific use of OTP memory. As such, in this description, it will be understood that OTP memory envisions any programmable read-only memory or field programmable non-volatile memory suitable for a given application of a solution.

As used in this description, the terms “component,” “database,” “module,” “system,” and the like are intended to refer to a computer-related entity, either hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device may be a component. One or more components may reside within a process and/or thread of execution, and a component may be localized on one computer and/or distributed between two or more computers. In addition, these components may execute from various computer readable media having various data structures stored thereon. The components may communicate by way of local and/or remote processes such as in accordance with a signal having one or more data packets (e.g., data from one component interacting with another component in a local system, distributed system, and/or across a network such as the Internet with other systems by way of the signal).

In this description, the terms “central processing unit (“CPU”),” “digital signal processor (“DSP”),” “graphical processing unit (“GPU”),” and “chip” are used interchangeably. Moreover, a CPU, DSP, GPU or a chip may be comprised of one or more distinct processing components generally referred to herein as “core(s).”

In this description, the term “portable computing device” (“PCD”) is used to describe any device operating on a limited capacity power supply, such as a battery. Although battery operated PCDs have been in use for decades, technological advances in rechargeable batteries coupled with the advent of third generation (“3G”) and fourth generation (“4G”) wireless technology have enabled numerous PCDs with multiple capabilities. Therefore, a PCD may be a cellular telephone, a satellite telephone, a pager, a PDA, a smartphone, a navigation device, a smartbook or reader, a media player, a combination of the aforementioned devices, a laptop computer with a wireless connection, among others.

In this description, the terms “bootstrapping,” “boot,” “reboot,” “boot mode,” “boot sequence,” “boot phase” and the like are meant to refer to the initial set of operations that a PCD performs at the direction of the primary boot loader (“PBL”) when the PCD is initially powered on including, but not limited to, loading the operating system, subsequent images corresponding to different scenarios such as factory provision or normal boot up, and preparing the various PCD components for use. Notably, exemplary embodiments of the solutions are described within the context of modifying PBL instructions; however, it is envisioned that certain embodiments of the solutions may be applicable to other instruction and/or data sets stored in non-volatile memory and in need of modification.

In current systems and methods, the PBL instructions reside entirely in unchangeable mask ROM. Extensive modifications to the PBL instructions after manufacture of the mask ROM may dictate scrapping the mask ROM and starting over. Minor changes to the PBL instructions, however, may be accommodated through patches applied through fuses. Fuses provide a limited amount of flexibility to make changes to the code programmed in the ROM.

Because the ability to modify PBL instructions after tape-out of a chip is limited to the capacity represented by fuses in the PCD, designers have to be extremely careful in developing the PBL code prior to the tape-out process. The time and care taken by designers translates into more expensive chips and slower lead times to market. To overcome these limitations, flexible ROM storage (“FRS”) systems and methods couple OTP memory banks with mask ROM memory banks for shared duties in storage of PBL instructions and data. Advantageously, by using OTP memory in couple with mask ROM, the number of fuses needed to accommodate changes to the initial instantiation of PBL instructions may be reduced, thereby saving physical space in a PCD with form factor constraints. Additionally, by using the OTP memory in this manner, embodiments of FRS systems and methods may provide for increased capacity to make changes to the PBL content after tape-out of the mask ROM without sacrificing security of the PBL.

As mentioned above, limitations on using mask ROM for the entire storage of PBL instructions include long lead times to market that result from the inflexibility of mask ROM to accommodate instruction and/or data modification. As an example, suppose that a typical six-week lead-time for design and manufacture of a mask ROM component during the development of a PCD is reduced to one week. In reaction to the shortened lead time, designers move forward with a previous instantiation of PBL instructions, or a new PBL with certain new functions not implemented, with limited modifications, and load it into the metal mask ROM. After verification, it is discovered that a significant portion of the PBL driver, 5% for example, is questionable. Again, because of the shortened lead-time, the designers have no choice but to move forward to mass production of the mask ROM.

Inevitably, the 5% of “bad” code will present a huge, maybe insurmountable, problem post-manufacture of the mask ROM because there may not be enough fuses in the PCD to accommodate all the patching that will be required to “fix” the 5% of code. With FRS solutions, however, closely coupled OTP memory may provide a large blank memory capacity that can be used in conjunction with the fuses to correct the questionable portions of the PBL driver.

Returning to the example, suppose that the 5% of questionable PBL code opened up a lot of bugs that required a significant amount of rework to the PBL driver. Further suppose that the volume of rework exceeds the capacity of the fuses but could easily be stored in an available OTP memory component. In this situation, an FRS embodiment may provide for storage of the reworked PBL code portions into the OTP memory component and then use a fuse for storage of a pointer to the OTP memory instead of for storage of the reworked PBL code. Advantageously, when a request for questionable PBL code is received at a security controller, the fuse points to the reworked PBL code in the OTP, thereby branching the request to the OTP memory component and bypassing the problematic PBL code in the mask ROM.

As another application, FRS embodiments may provide for accommodation of newly added or upgraded functionality in the PCD by using the fuses again to map away from the mask ROM and point to an updated image of the PBL driver in the OTP memory. The updated image, which may have been loaded into the OTP memory at the time the functionality of the PCD was changed or upgraded, may be required to support the new functionality which would otherwise not be possible without replacement of the mask ROM or addition of extra fuses.

Notably, one of ordinary skill in the art will recognize that FRS embodiments optimize the capacity of fuses in the PCD because the fuses do not necessarily need to contain patch code but, rather, only need to contain pointers to patch code stored in a coupled OTP memory. Along these lines, it is envisioned that certain embodiments of FRS systems and methods may include a portion of fuses with pointers to OTP memory and a portion of fuses with patch code stored therein, while other embodiments may use fuses entirely for storage of pointers to code stored in OTP memory.

It is also envisioned that some FRS embodiments may not include fuses at all but, instead, use code stored in the OTP memory to either direct requests to the mask ROM or respond to requests with instructions and/or data instantiated in the OTP itself. It is further envisioned that certain FRS embodiments include mask ROM instructions that branch to the OTP memory. In such embodiments, a fuse may replace the instruction in the mask ROM or change it into a branch to the OTP memory.

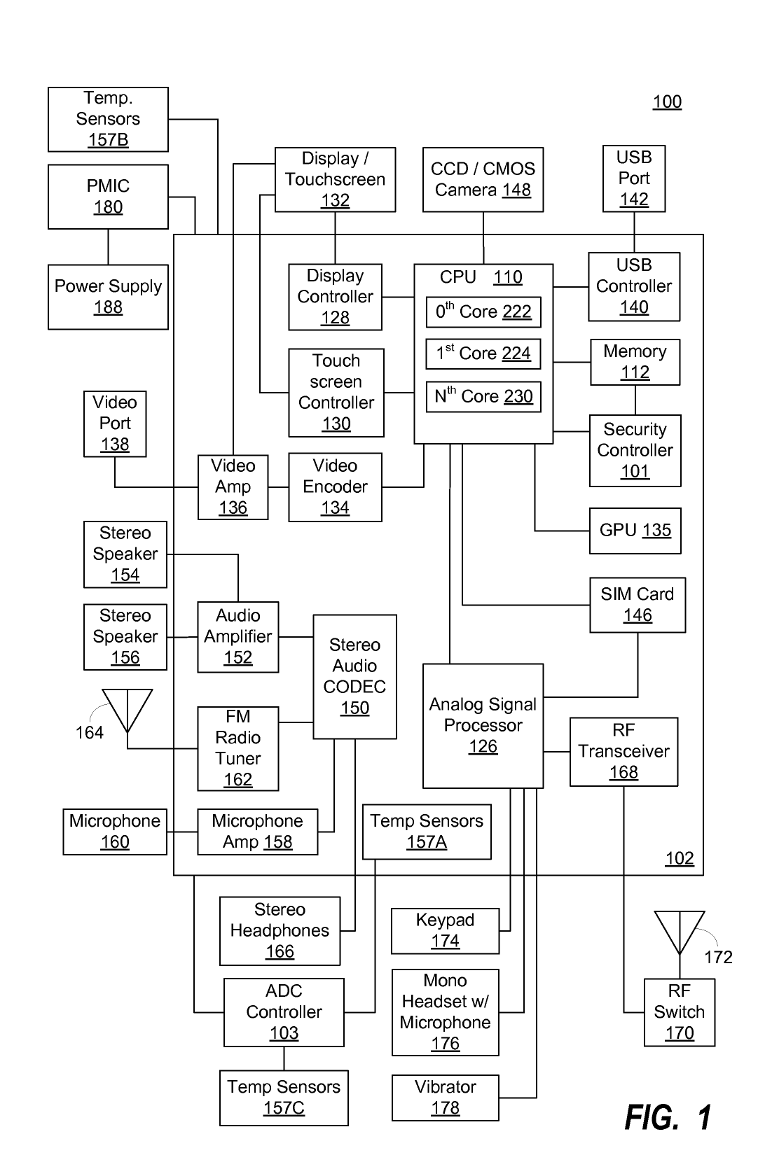

FIG. 1 is a functional block diagram illustrating an exemplary, non-limiting aspect of a PCD 100 in the form of a wireless telephone for implementing flexible ROM storage (“FRS”) methods and systems. As shown, the PCD 100 includes an on-chip system 102 that includes a multi-core central processing unit (“CPU”) 110 and an analog signal processor 126 that are coupled together. The CPU 110 may comprise a zeroth core 222, a first core 224, and an Nth core 230 as understood by one of ordinary skill in the art. Further, instead of a CPU 110, a digital signal processor (“DSP”) may also be employed as understood by one of ordinary skill in the art.

In general, the security controller 101 may be formed from hardware and/or firmware and may be responsible for receiving requests for instructions and/or data associated with a primary boot loader (“PBL”) and using fuses to either return patch instructions or point to patch instructions stored in an OTP memory component coupled with a mask ROM. Advantageously, using the fuses to point to instructions and/or data stored in an OTP memory component, a security controller 101 may provide for modification and/or update of PBL driver code stored in a mask ROM without needing excessive numbers of fuses.

As illustrated in FIG. 1, a display controller 128 and a touch screen controller 130 are coupled to the digital signal processor 110. A touch screen display 132 external to the on-chip system 102 is coupled to the display controller 128 and the touch screen controller 130. PCD 100 may further include a video encoder 134, e.g., a phase-alternating line (“PAL”) encoder, a sequential couleur avec memoire (“SECAM”) encoder, a national television system(s) committee (“NTSC”) encoder or any other type of video encoder 134. The video encoder 134 is coupled to the multi-core CPU 110. A video amplifier 136 is coupled to the video encoder 134 and the touch screen display 132. A video port 138 is coupled to the video amplifier 136. As depicted in FIG. 1, a universal serial bus (“USB”) controller 140 is coupled to the CPU 110. Also, a USB port 142 is coupled to the USB controller 140. A memory 112, which may include a PoP memory, a cache 116, a mask ROM/Boot ROM 113, a boot OTP memory 115 (see subsequent Figures) may also be coupled to the CPU 110. A subscriber identity module (“SIM”) card 146 may also be coupled to the CPU 110. Further, as shown in FIG. 1, a digital camera 148 may be coupled to the CPU 110. In an exemplary aspect, the digital camera 148 is a charge-coupled device (“CCD”) camera or a complementary metal-oxide semiconductor (“CMOS”) camera.

As further illustrated in FIG. 1, a stereo audio CODEC 150 may be coupled to the analog signal processor 126. Moreover, an audio amplifier 152 may be coupled to the stereo audio CODEC 150. In an exemplary aspect, a first stereo speaker 154 and a second stereo speaker 156 are coupled to the audio amplifier 152. FIG. 1 shows that a microphone amplifier 158 may be also coupled to the stereo audio CODEC 150. Additionally, a microphone 160 may be coupled to the microphone amplifier 158. In a particular aspect, a frequency modulation (“FM”) radio tuner 162 may be coupled to the stereo audio CODEC 150. Also, an FM antenna 164 is coupled to the FM radio tuner 162. Further, stereo headphones 166 may be coupled to the stereo audio CODEC 150.

FIG. 1 further indicates that a radio frequency (“RF”) transceiver 168 may be coupled to the analog signal processor 126. An RF switch 170 may be coupled to the RF transceiver 168 and an RF antenna 172. As shown in FIG. 1, a keypad 174 may be coupled to the analog signal processor 126. Also, a mono headset with a microphone 176 may be coupled to the analog signal processor 126. Further, a vibrator device 178 may be coupled to the analog signal processor 126. FIG. 1 also shows that a power supply 188, for example a battery, is coupled to the on-chip system 102 through a power management integrated circuit (“PMIC”) 180. In a particular aspect, the power supply 188 includes a rechargeable DC battery or a DC power supply that is derived from an alternating current (“AC”) to DC transformer that is connected to an AC power source.

The CPU 110 may also be coupled to one or more internal, on-chip thermal sensors 157A as well as one or more external, off-chip thermal sensors 157B. The on-chip thermal sensors 157A may comprise one or more proportional to absolute temperature (“PTAT”) temperature sensors that are based on vertical PNP structure and are usually dedicated to complementary metal oxide semiconductor (“CMOS”) very large-scale integration (“VLSI”) circuits. The off-chip thermal sensors 157B may comprise one or more thermistors. The thermal sensors 157 may produce a voltage drop that is converted to digital signals with an analog-to-digital converter (“ADC”) controller (not shown). However, other types of thermal sensors 157 may be employed.

The touch screen display 132, the video port 138, the USB port 142, the camera 148, the first stereo speaker 154, the second stereo speaker 156, the microphone 160, the FM antenna 164, the stereo headphones 166, the RF switch 170, the RF antenna 172, the keypad 174, the mono headset 176, the vibrator 178, thermal sensors 157B, the PMIC 180 and the power supply 188 are external to the on-chip system 102. It will be understood, however, that one or more of these devices depicted as external to the on-chip system 102 in the exemplary embodiment of a PCD 100 in FIG. 1 may reside on chip 102 in other exemplary embodiments.

In a particular aspect, one or more of the method steps described herein may be implemented by executable instructions and parameters stored in the memory 112 or as form the security controller 101 and/or its fuses. Further, the security controller 101, the memory 112, the instructions stored therein, or a combination thereof may serve as a means for performing one or more of the method steps described herein.

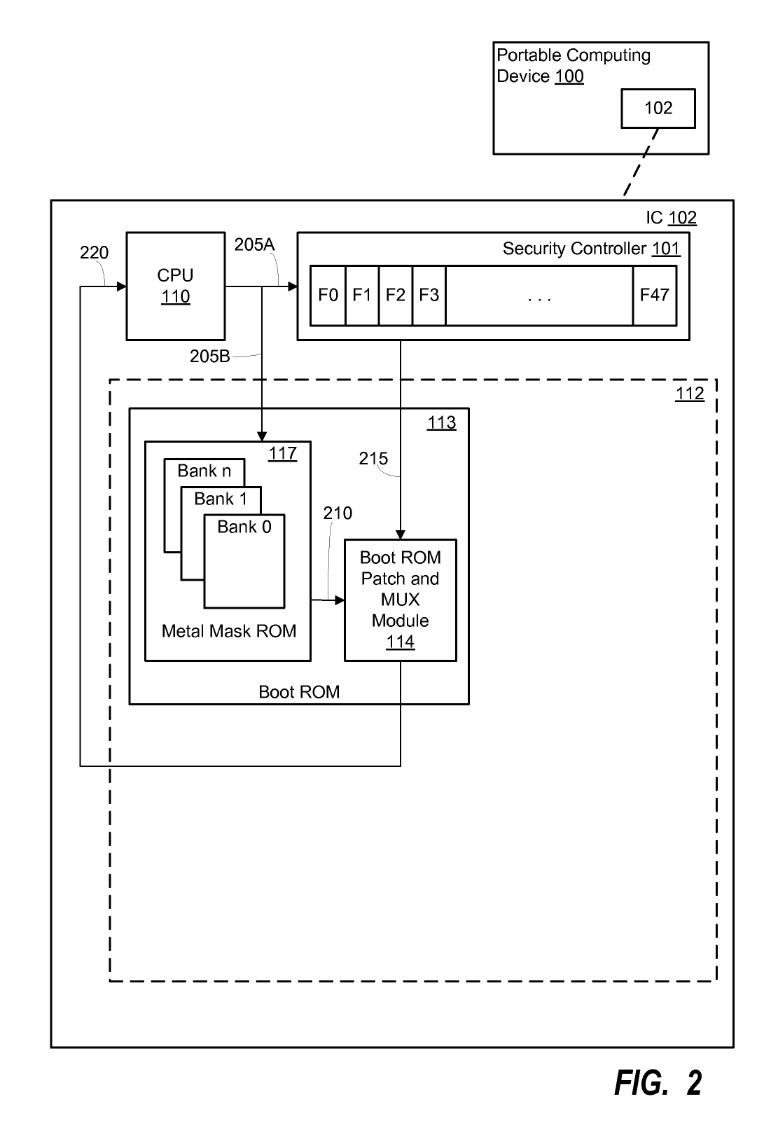

FIG. 2 is a functional block diagram illustrating an embodiment of an on-chip system 102 for executing a primary boot loader (“PBL”) stored entirely in a boot ROM 113 of a PCD 100. As indicated by the arrows 205A, 205B in the FIG. 2 illustration, during a boot sequence, addresses emanate from the CPU 110 and are directed to both the security controller 101 and the mask ROM 117 contained in the boot ROM 113. As is understood by one of ordinary skill in the art, the CPU 110 could be fetching instructions and/or data associated with the PBL that are stored at the address(es) in the mask ROM 117.

If the particular instructions or data stored at the requested address has been patched, i.e. a “patch valid” bit has been set for that address by the security controller 101, the patch data held by a fuse (F0, for example) is forwarded (arrow 215) to the Boot ROM Patch and Multiplexor Module (“MUX” module) 114. The MUX module 114 overrides the PBL data coming out of the metal mask ROM 117 (arrow 210) and returns the patch code or patch data, as the case may be, to the CPU 110 (arrow 220) instead of the original instantiation of the code or data stored in the mask ROM 117. If no valid patch data is held by a fuse of the security controller 101, the MUX module 114 returns the original instructions and/or data to the CPU 110 (arrow 220).

Notably, the particular embodiment of the on-chip system 102 illustrated in FIG. 2 is limited in its capacity to modify the PBL instructions and data originally instantiated in the mask ROM 117 by the capacity of the fuses (F0 . . . F47) to carry patch instructions and data. Moreover, and as one of ordinary skill in the art will recognize, increasing the capacity of the particular embodiment illustrated in FIG. 2 to accommodate PBL code modification requires the addition of fuses beyond the exemplary 47 fuses shown in the illustration. Because space within a PCD may come at a premium, the addition of space consuming fuses may not be practical.

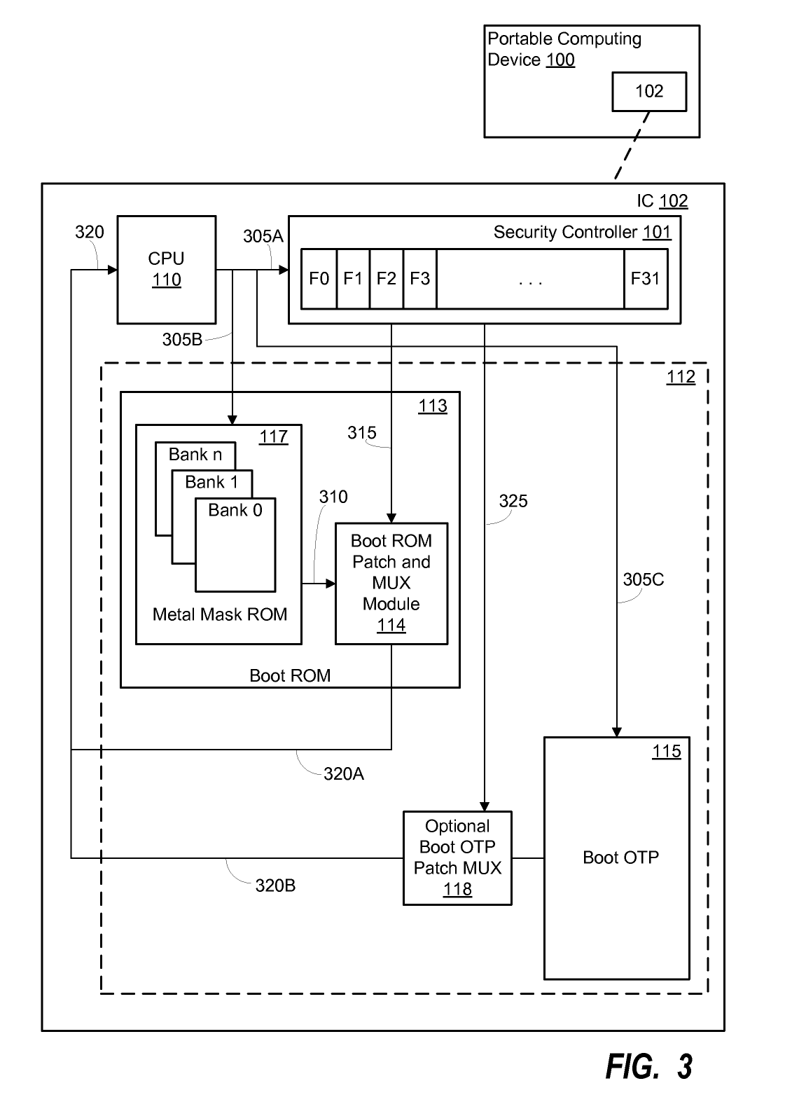

FIG. 3 is a functional block diagram illustrating an embodiment of an on-chip system 102 for executing a primary boot loader (“PBL”) of a PCD 100 using a flexible ROM storage (“FRS”) arrangement according to an embodiment of the invention. In the FIG. 3 illustration, it can be seen that a boot OTP memory component 115 is closely coupled to the boot ROM 113 and the security controller 101. As in the FIG. 2 illustration, the CPU 110 may direct requests for data and/or instructions stored at an address in the mask ROM 117 to both the security controller (arrow 305A) and the mask ROM 117 (arrow 305B). With the addition of boot OTP memory 115, the request that falls into the OTP memory address range may be sent to both boot OTP 115 (arrow 305C) and optionally to the security controller (arrow 305A).

If the particular instructions or data stored at the requested address has been patched, i.e. a “patch valid” bit has been set for that address by the security controller 101, the patch data held by a fuse (F0, for example) may be forwarded (arrow 315) to the MUX module 114. In such case, the MUX module 114 overrides the PBL data coming out of the metal mask ROM 117 (arrow 310) and returns the patch code or patch data, as the case may be, to the CPU 110 (arrow 320A) instead of the original instantiation of the code or data stored in the mask ROM 117. As in the FIG. 2 illustration, if a “patch valid” bit has not been set for a fuse of the security controller 101, the MUX module 114 returns the original instructions and/or data stored in the mask ROM 117 to the CPU 110 (arrow 220).

Alternatively, however, in the FRS system of FIG. 3 a “patch valid” bit may indicate that the fuse holds a patch instruction/data that when executed by the CPU 110, will cause a branch to the Boot OTP 115. In such case, the instruction that originated from the patch fuse and comes out of the mux (arrow 320A), will cause the CPU to branch to boot OTP 115, and start the operation from the boot OTP thereafter, thereby bypassing the Boot ROM 113 by transferring execution to fetch from boot OTP 116. The CPU 110 will start requesting for instructions or data in the boot OTP 115 (arrow 305C), the instructions and/or data stored at the Boot OTP 115 are returned to the CPU 110 (arrow 320B).

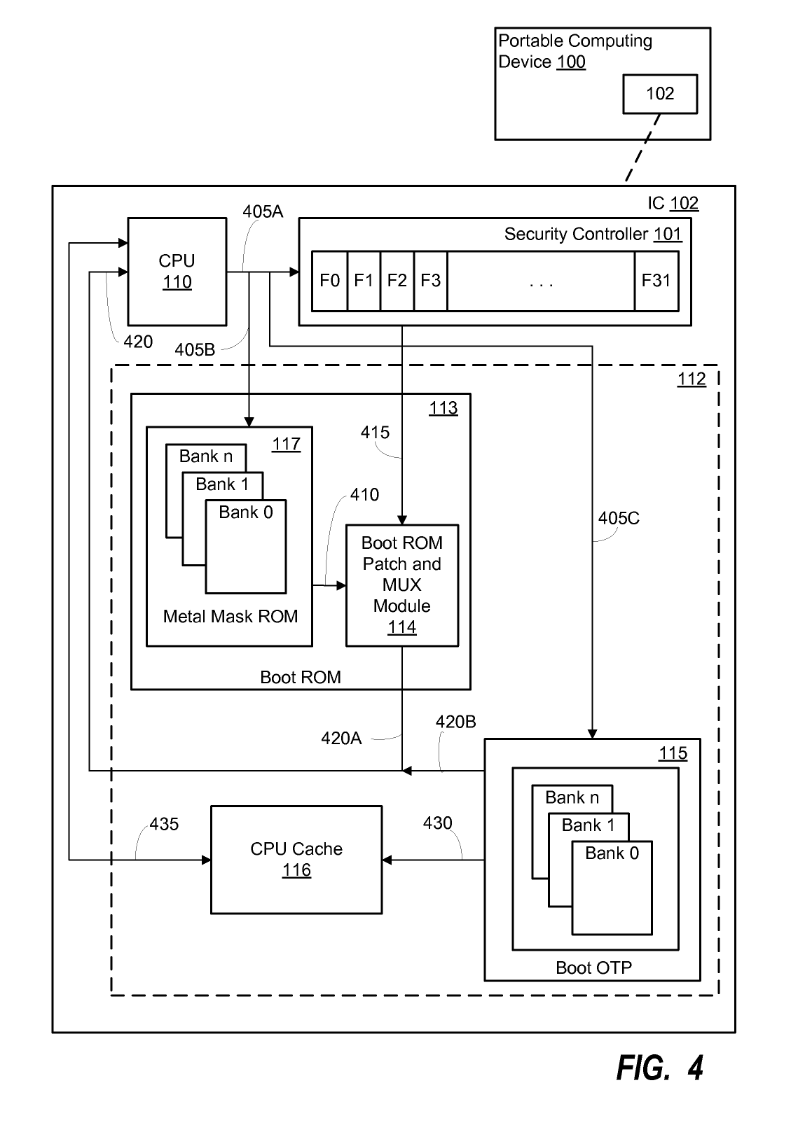

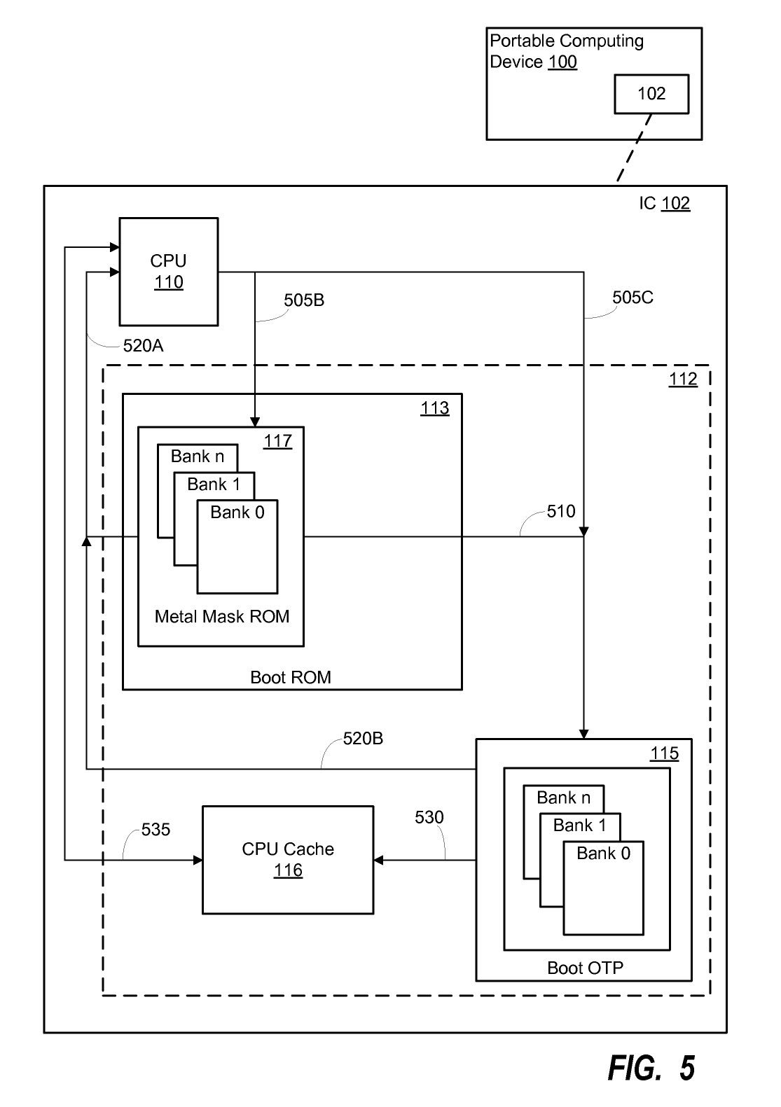

Advantageously, by using OTP memory 115 in conjunction with the Boot ROM 113, FRS systems and methods may provide extended memory capacity for holding replacement code and/or data associated with a PBL driver. Moreover, by storing PBL instructions and/or data in the Boot OTP 115, FRS embodiments optimize fuse capacity as certain fuses of the security controller 101 may need to only hold one patch to branch to OTP memory 115 addresses instead of entire code patches or replacement data. Notably, the FIG. 3 illustration depicts thirty two fuses in the security controller 101, as opposed to the forty eight fuses depicted in the FIG. 2 illustration, to suggest that FRS systems and methods may enable designers to reduce the number of fuses required in a particular PCD 100. One of ordinary skill in the art will recognize that depiction of forty eight fuses in the FIG. 2 illustration, and thirty two fuses in the FIG. 3 (as well as FIGS. 4-5) illustration, is arbitrary and shown for illustrative purposes only.

FIG. 4 is a functional block diagram illustrating an embodiment of an on-chip system 102 for executing a primary boot loader (“PBL”) of a PCD 100 using a flexible ROM storage (“FRS”) arrangement according to an embodiment of the invention that includes a cache 116. Because an OTP memory component 115 may be slower in response time than a Boot ROM 113 (e.g., 40 ns versus 1.3 ns), some embodiments of an FRS system or method may enable a CPU cache 116 during the boot sequence. The cache 116, whether enabled as a cache or as a high performance tightly coupled memory (if not enabled as a cache), may then be used by the FRS embodiment for storage of a copy of all or part of the PBL instructions and data held in the Boot OTP 115. Advantageously, in such embodiments the Boot OTP 115 may need to be accessed only once for a given patch data at its relatively slow rate while any repetition of instruction or data may be directed to the faster cache 116.

Referring to the FIG. 4 illustration, it can be seen that a boot OTP memory component 115 is closely coupled to the boot ROM 113 and the security controller 101. Notably, the Boot OTP 115 is depicted as being divided into a series of memory banks As in the previous illustrations, the CPU 110 may direct requests for data and/or instructions stored at an address in the mask ROM 117 to both the security controller (arrow 405A) and the mask ROM 117 (arrow 405B).

If the particular instructions or data stored at the requested address has been patched, i.e. a “patch valid” bit has been set for that address by the security controller 101, the patch data held by a fuse (F0, for example) may be forwarded (arrow 415) to the MUX module 114. In such case, the MUX module 114 overrides the PBL data coming out of the metal mask ROM 117 (arrow 410) and returns the patch code or patch data, as the case may be, to the CPU 110 (arrow 420A) instead of the original instantiation of the code or data stored in the mask ROM 117. If a “patch valid” bit has not been set for a fuse of the security controller 101, the MUX module 114 returns the original instructions and/or data stored in the mask ROM 117 to the CPU 110 (arrow 420A).

Alternatively, however, in the FRS system of FIG. 4 a “patch valid” bit may indicate that the fuse holds a patch that may cause CPU 110 to fetch PBL code and/or data stored at the Boot OTP 115. In such case, the request is directed to an address of the Boot OTP 115, thereby bypassing the Boot ROM 113 (arrow 425). The patch instructions and/or data stored at the Boot OTP 115 are returned to the CPU 110 (arrow 420B) and copied into the CPU cache 116 (arrow 430). Advantageously, by copying the instructions stored in the Boot OTP 115 into the cache 116, subsequent requests for the instructions or data may be provided to the CPU from the cache 116 (arrow 435) instead of the security controller 101 and mask ROM 117.

Additionally, because the Boot OTP 115 may be divided into banks with individual circuitry, the slower programming time of the Boot OTP 115 relative to the Boot ROM 113 may be accommodated via parallel programming methodologies. In this way, each bank may be programmed concurrently. As an example, it is envisioned that a 48 Kb OTP may be divided into 2, 4, or 8 banks, thereby enabling the programming of the entire OTP memory in parallel, thereby possibly shortening the programming time for the entire OTP to the time that it takes to program a single bank of OTP.

Further regarding programming the Boot OTP 115, it is envisioned that some embodiments of the FRS solutions may include an encryption of the instructions and/or data that is stored in the Boot OTP 115. Because certain instructions and data must be secured in order to prevent hacking or compromising of the data, such as PBL instructions and data for example, the code and data designated for storage in the Boot OTP 115 after tape-out of the mask ROM may require encryption and decryption methodologies, as would be understood by one of ordinary skill in the art of encryption.

FIG. 5 is a functional block diagram illustrating an embodiment of an on-chip system 102 for executing a primary boot loader (“PBL”) of a PCD 100 using a flexible ROM storage (“FRS”) arrangement according to an embodiment of the invention that branches from mask ROM 117 to Boot OTP 115. In the FIG. 5 embodiment, the CPU may send address-based requests directly to the mask ROM 117 (arrow 505). Notably, although the security controller 101 is not depicted in the FIG. 5 illustration, it will be understood that arrow 505 may pass through a fuse en route to the mask ROM 117. The address may contain PBL instructions and/or data that are returned to the CPU 110 (arrow 520A) or may contain a pointer that branches to the Boot OTP 115 (arrow 510). Briefly returning to the example of a PBL code with 5% questionable code after verification prior to manufacture of the mask ROM 113, the questionable code may be replaced using one patch to branch to the Boot OTP 115 prior to tape-out of the chip, and place the new, well verified code in the boot OTP.

When pointed to the Boot OTP 115, the Boot OTP 115 may return the correct, well verified instructions or data stored therein to the CPU (arrow 520B). In some embodiments, the Boot OTP 115 instructions and/or data may be copied into a CPU cache 116 (arrow 530) so that subsequent requests for the instructions and/or data may be made by the CPU 110 to the faster cache 116 (arrow 535).

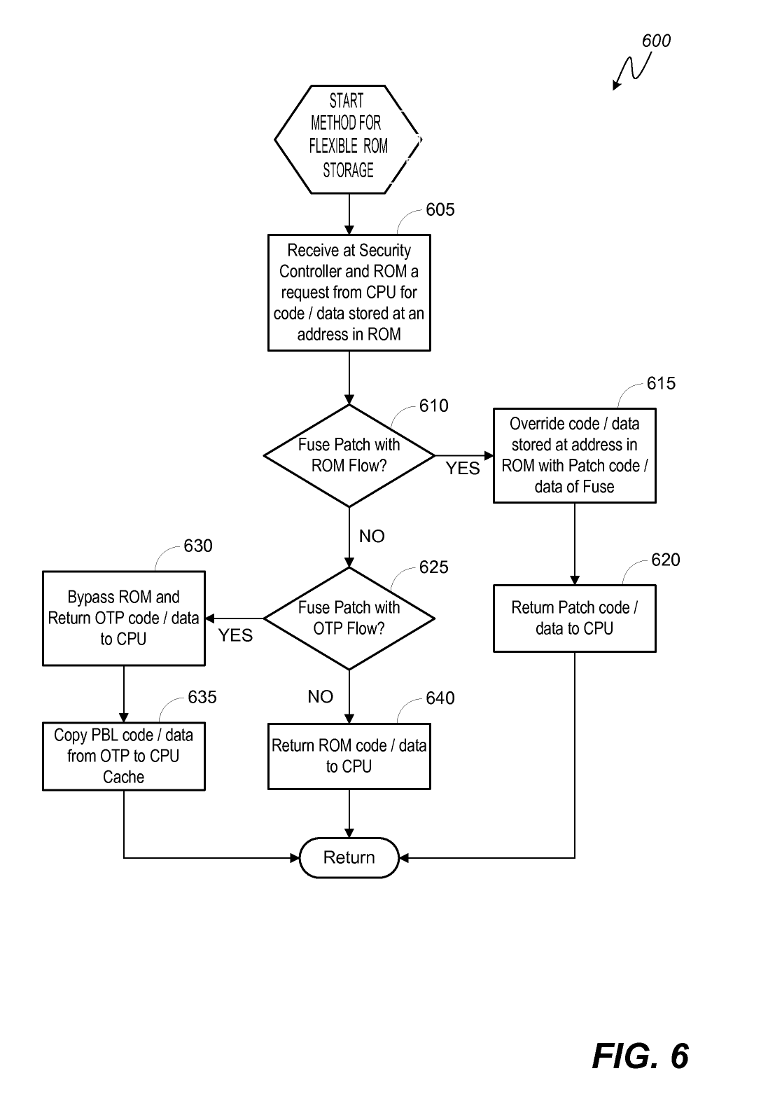

FIG. 6 is a logical flowchart illustrating a method 600 for flexible ROM storage (“FRS”) of primary boot loader (“PBL”) instructions and data. Beginning at block 605, the CPU 110 may send a request for PBL instructions or data stored at a location in mask ROM 117. The request is sent to both the mask ROM 117 and the security controller 101 that controls one or more fuses, as is understood by one of ordinary skill in the art. In some embodiments, the CPU 110 may send a request for PBL instructions or data stored at a location in boot OTP 115, as illustrated by 305C, 405C, and 505C in the Figures. At decision block 610, if a fuse of the security controller 101 contains valid patch code or data that replaces original code or data in the mask ROM 117 and instructs the CPU to continue its execution flow in the mask ROM 117, the process follows the “yes” branch to block 615. At block 615 the patch code or data contained by the fuse is forwarded to the MUX module 114 which overrides the original instantiation of the instructions or data in the mask ROM 117 and returns the patch code or data to the CPU 110 at block 620.

Returning to decision block 610, if no fuse with patch code or data that replaces original code or data in the mask ROM 117 and instructs the CPU to continue its execution flow in the mask ROM 117 is identified, the process follows the “no” branch to decision block 625. At decision block 625, if a fuse of the security controller 101 contains valid patch code or data that replaces original code or data with a branch to the OTP 115, then the “yes” branch is followed to block 630 and the mask ROM 117 is bypassed to the Boot OTP 115. Notably, depending on the patch value in the fuse, the patch may replace the original instruction or data and still instruct the CPU to continue the original execution flow in ROM, or it can replace the original instruction or data into a branch into boot OTP. In the latter case, the CPU may continue to fetch the instructions or data in the boot OTP after the patch.

Returning to the method 600 at block 630, at the Boot OTP 115, patch code or data associated with the requested address is queried and returned to the CPU 110. Subsequently, at block 635 the patch code or data in the Boot OTP 115 is copied to a cache 116 so that the CPU 110 may more quickly access the data for future requests.

Returning to the decision block 625, if no fuse of the security controller 101 contains replacement code or data (as represented in method 600 by the “yes” branches of decision blocks 610 and 625), then the instructions or data originally instantiated at the requested address in the mask ROM 117 is presumed valid and the “no” branch is followed to block 640. At block 640, the original code or data, such as PBL code or data, is queried from the mask ROM and returned to the CPU 110 via the MUX module 114. The process 600 returns.

Certain steps in the processes or process flows described in this specification naturally precede others for the invention to function as described. However, the invention is not limited to the order of the steps described if such order or sequence does not alter the functionality of the invention. That is, it is recognized that some steps may performed before, after, or parallel (substantially simultaneously with) other steps without departing from the scope and spirit of the invention. In some instances, certain steps may be omitted or not performed without departing from the invention. Further, words such as “thereafter”, “then”, “next”, etc. are not intended to limit the order of the steps. These words are simply used to guide the reader through the description of the exemplary method.

Additionally, one of ordinary skill in programming is able to write computer code or identify appropriate hardware and/or circuits to implement the disclosed invention without difficulty based on the flow charts and associated description in this specification, for example. Therefore, disclosure of a particular set of program code instructions or detailed hardware devices is not considered necessary for an adequate understanding of how to make and use the invention. The inventive functionality of the claimed computer implemented processes is explained in more detail in the above description and in conjunction with the drawings, which may illustrate various process flows.

In one or more exemplary aspects, the functions described may be implemented in hardware, software, firmware, or any combination thereof. If implemented in software, the functions may be stored on or transmitted as one or more instructions or code on a computer-readable medium. Computer-readable media include both computer storage media and communication media including any medium that facilitates transfer of a computer program from one place to another. A storage media may be any available media that may be accessed by a computer. By way of example, and not limitation, such computer-readable media may comprise RAM, ROM, EEPROM, CD-ROM or other optical disk storage, magnetic disk storage or other magnetic storage devices, or any other medium that may be used to carry or store desired program code in the form of instructions or data structures and that may be accessed by a computer.

Therefore, although selected aspects have been illustrated and described in detail, it will be understood that various substitutions and alterations may be made therein without departing from the spirit and scope of the present invention, as defined by the following claims.

What is claimed is:

1. A method for flexible read only memory (“ROM”) storage of coded instructions in a portable computing device (“PCD”), the method comprising:
receiving, at a mask ROM component and a security controller, a request for coded instructions stored at an address of the mask ROM component, wherein the security controller comprises a plurality of fuses;
determining that a fuse associated with the address contains instructions for branching the request to a one time programmable (“OTP”) memory component;
retrieving coded instructions stored in the OTP memory component; and
returning the retrieved coded instructions to a processor, wherein returning the retrieved coded instructions comprises bypassing the mask ROM.

2. The method of claim 1, wherein the coded instructions are associated with a primary boot loader (“PBL”).

3. The method of claim 1, further comprising:
copying the retrieved coded instructions to a cache associated with the processor.

4. The method of claim 3, further comprising:
receiving a second request for the coded instructions at the cache.

5. The method of claim 1, wherein the coded instructions stored in the OTP memory component were encrypted at the time of programming to the OTP memory component.

6. The method of claim 1, wherein the OTP memory component was divided into a series of memory banks at the time of programming.

7. The method of claim 6, wherein the series of memory banks were programmed in parallel.

8. The method of claim 1, further comprising:
receiving, at the mask ROM component and the security controller, a second request for coded instructions stored at a second address of the mask ROM component;
determining that a fuse associated with the second address contains patch instructions; and
returning the patch instructions to the processor, wherein returning the patch instructions comprises overriding return of the coded instructions stored at the second address of the mask ROM.

9. The method of claim 1, further comprising:
receiving, at the mask ROM component and the security controller, a second request for coded instructions stored at a second address of the mask ROM component;
determining that none of the plurality of fuses is associated with the second address; and
returning the coded instructions to the processor, wherein returning the coded instructions comprises returning the coded instructions stored at the second address of the mask ROM.

10. The method of claim 1, wherein the PCD comprises a mobile phone.

11. A computer system for flexible read only memory (“ROM”) storage of coded instructions in a portable computing device (“PCD”), the system comprising:
a mask ROM component;
a one time programmable (“OTP”) memory component;
a multiplexor (“MUX”) module; and
a security controller comprising a plurality of fuses;
wherein:
the security controller and the mask ROM component are configured to receive a request for coded instructions stored at an address of the mask ROM component;
the security controller is configured to determine that a fuse associated with the address contains instructions for branching the request to a one time programmable (“OTP”) memory component;
the security controller is configured to forward the request to the OTP memory component; and
the OTP memory component is configured to return the coded instructions to a processor, wherein returning the coded instructions comprises bypassing the mask ROM.

12. The computer system of claim 11, wherein the coded instructions are associated with a primary boot loader (“PBL”).

13. The computer system of claim 11, wherein the OTP memory component is further configured to:
copy the coded instructions to a cache associated with the processor.

14. The computer system of claim 13, wherein the cache is configured to:
receive a second request for the coded instructions.

15. The computer system of claim 11, wherein the coded instructions stored in the OTP memory component were encrypted at the time of programming to the OTP memory component.

16. The computer system of claim 11, wherein the OTP memory component was divided into a series of memory banks at the time of programming.

17. The computer system of claim 16, wherein the series of memory banks were programmed in parallel.

18. The computer system of claim 11, wherein:
the security controller and the mask ROM are further configured to:
receive a second request for coded instructions stored at a second address of the mask ROM component;
the security controller is further configured to:
determine that a fuse associated with the second address contains patch instructions; and
the MUX module is configured to:
return the patch instructions to the processor, wherein returning the patch instructions comprises overriding return of the coded instructions stored at the second address of the mask ROM.

19. The computer system of claim 11, wherein:
the security controller and the mask ROM are further configured to:
receive a second request for coded instructions stored at a second address of the mask ROM component;
the security controller is further configured to:
determine that none of the plurality of fuses is associated with the second address; and
the MUX module is configured to:
return the coded instructions to the processor, wherein returning the coded instructions comprises returning the coded instructions stored at the second address of the mask ROM.

20. The computer system of claim 1, wherein the PCD comprises a mobile phone.

21. A computer system for flexible read only memory (“ROM”) storage of coded instructions in a portable computing device (“PCD”), the system comprising:
means for receiving, at a mask ROM component and a security controller, a request for coded instructions stored at an address of the mask ROM component, wherein the security controller comprises a plurality of fuses;
means for determining that a fuse associated with the address contains instructions for branching the request to a one time programmable (“OTP”) memory component;
means for retrieving coded instructions stored in the OTP memory component; and
means for returning the retrieved coded instructions to a processor, wherein returning the retrieved coded instructions comprises bypassing the mask ROM.

22. The computer system of claim 21, wherein the coded instructions are associated with a primary boot loader (“PBL”).

23. The computer system of claim 21, further comprising:
means for copying the retrieved coded instructions to a cache associated with the processor.

24. The computer system of claim 23, further comprising:
means for receiving a second request for the coded instructions at the cache.

25. The computer system of claim 21, wherein the coded instructions stored in the OTP memory component were encrypted at the time of programming to the OTP memory component.

26. The computer system of claim 21, wherein the OTP memory component was divided into a series of memory banks at the time of programming.

27. The computer system of claim 26, wherein the series of memory banks were programmed in parallel.

28. The computer system of claim 21, further comprising:
means for receiving, at the mask ROM component and the security controller, a second request for coded instructions stored at a second address of the mask ROM component;
means for determining that a fuse associated with the second address contains patch instructions; and
means for returning the patch instructions to the processor, wherein returning the patch instructions comprises overriding return of the coded instructions stored at the second address of the mask ROM.

29. The computer system of claim 21, further comprising:
means for receiving, at the mask ROM component and the security controller, a second request for coded instructions stored at a second address of the mask ROM component;
means for determining that none of the plurality of fuses is associated with the second address; and
means for returning the coded instructions to the processor, wherein returning the coded instructions comprises returning the coded instructions stored at the second address of the mask ROM.

30. The computer system of claim 21, wherein the PCD comprises a mobile phone.
